(19) United States
(12) Patent Application Publication
(10) Pub. No.: US 2026/0365372 A1
(43) Pub. Date: Nov. 19, 2026

(54) PACKAGE, AND METHOD FOR COLLECTING LIQUID EJECTION HEAD

(71) Applicant: CANON KABUSHIKI KAISHA, Tokyo (JP)

(72) Inventor: TOSHIO NAKANO, Tokyo (JP)

(21) Appl. No.: 19/631,948

(22) Filed: Mar. 27, 2026

(30) Foreign Application Priority Data
Apr. 1, 2025 (JP) 2025-060685

(51) Int. Cl. B65D 25/10; B41J 2/175; B65D 85/68

(52) U.S. Cl. CPC B65D 25/101; B41J 2/17533; B65D 85/68; B65D 2585/689

(57) ABSTRACT

Provided is a technology which suppresses a decrease in the reuse rate of a liquid ejection head. For this purpose, a package includes: a container main body capable of housing the liquid ejection head inserted from a main body opening having an edge portion; and a fixation member having an edge holding portion configured to clamp and hold the edge portion, and a covering portion configured to restrict popping out of the liquid ejection head from the main body opening. The technology described in the present Specification can contribute to achievement of a sustainable society such as a decarbonized/circular society.

### BACKGROUND

### Field of the Technology

The present disclosure relates to a package, and a method for collecting a liquid ejection head.

### Description of the Related Art

In order to increase the reuse rate of recycled products of liquid ejection heads, it is demanded to collect liquid ejection heads in reusable states with good conditions. A large difference occurs in recycling rate of recycled products between used liquid ejection heads collected in the state where the used liquid ejection heads are not covered with housing containers during the collection and used liquid ejection heads collected in the state where the used liquid ejection heads are housed in housing containers such that liquid ejection units are protected.

Japanese Patent Laid-Open No. 2012-51240 discloses holding a liquid ejection head by attaching an adhesive tape having a multi-layer configuration to a container and the liquid ejection head in order to ensure sufficient reliability against vibrations during distribution.

However, in the method of Japanese Patent Laid-Open No. 2012-51240, there is a possibility that the tape is peeled off due to deterioration of adhesiveness of the adhesive of the tape, leading to a possibility that the liquid ejection head pops out from the container to damage a head unit. There is a problem that in the case where the head unit of the liquid ejection head is damaged, the liquid ejection head cannot be reused, so that the reuse rate decreases.

### SUMMARY

Therefore, the present disclosure provides a technology capable of suppressing a decrease in the reuse rate of a liquid ejection head.

Hence, a package of the present disclosure is a package configured to house and hold a liquid ejection head, including: a container main body having a main body opening having an edge portion, the container main body being capable of housing the liquid ejection head inserted from the main body opening; and a fixation member having an edge holding portion configured to clamp and hold the edge portion, and a covering portion configured to restrict popping out of the liquid ejection head from the main body opening.

According to the present disclosure, a technology which suppresses a decrease in the reuse rate of a liquid ejection head can be provided.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram showing a liquid ejection head;

FIG. 1B is a diagram showing the liquid ejection head;

FIG. 1C is a diagram showing the liquid ejection head;

FIG. 2A is a diagram showing a housing container configured to house the liquid ejection head;

FIG. 2B is a diagram showing the housing container configured to house the liquid ejection head;

FIG. 2C is a diagram showing the housing container configured to house the liquid ejection head;

FIG. 3A is a diagram showing the housing container in which a pop-out preventing part is stored;

FIG. 3B is a diagram showing the housing container in which the pop-out preventing part is stored;

FIG. 4A is a diagram showing a container main body in which the liquid ejection head is housed;

FIG. 4B is a diagram showing the container main body in which the liquid ejection head is housed;

FIG. 5A is a diagram showing the container main body to which the pop-out preventing part is attached;

FIG. 5B is a diagram showing the container main body to which the pop-out preventing part is attached;

FIG. 6A is a diagram showing the pop-out preventing part;

FIG. 6B is a diagram showing the pop-out preventing part;

FIG. 7A is a diagram showing a procedure for attaching the pop-out preventing part to an edge portion of the container main body;

FIG. 7B is a diagram showing the procedure for attaching the pop-out preventing part to the edge portion of the container main body;

FIG. 7C is a diagram showing the procedure for attaching the pop-out preventing part to the edge portion of the container main body;

FIG. 7D is a diagram showing the procedure for attaching the pop-out preventing part to the edge portion of the container main body;

FIG. 7E is a diagram showing the procedure for attaching the pop-out preventing part to the edge portion of the container main body;

FIG. 8 is a diagram showing the pop-out preventing part attached to the container main body;

FIG. 9 is a flowchart showing steps of collecting the liquid ejection head;

FIG. 10A is a diagram showing a dimensional relation between the liquid ejection head and the container main body;

FIG. 10B is a diagram showing the dimensional relation between the liquid ejection head and the container main body;

FIG. 11A is a diagram showing a pop-out preventing part;

FIG. 11B is a diagram showing the pop-out preventing part;

FIG. 12A is a diagram showing a procedure for attaching the pop-out preventing part to the edge portion of the container main body;

FIG. 12B is a diagram showing the procedure for attaching the pop-out preventing part to the edge portion of the container main body;

FIG. 12C is a diagram showing the procedure for attaching the pop-out preventing part to the edge portion of the container main body;

FIG. 12D is a diagram showing the procedure for attaching the pop-out preventing part to the edge portion of the container main body;

FIG. 12E is a diagram showing the procedure for attaching the pop-out preventing part to the edge portion of the container main body;

FIG. 13 is a diagram showing a pop-out preventing part;

FIG. 14A is a diagram showing a procedure for attaching the pop-out preventing part to the edge portion of the container main body;

FIG. 14B is a diagram showing the procedure for attaching the pop-out preventing part to the edge portion of the container main body;

FIG. 14C is a diagram showing the procedure for attaching the pop-out preventing part to the edge portion of the container main body;

FIG. 14D is a diagram showing the procedure for attaching the pop-out preventing part to the edge portion of the container main body;

FIG. 14E is a diagram showing the procedure for attaching the pop-out preventing part to the edge portion of the container main body;

FIG. 15 is a diagram showing a pop-out preventing part;

FIG. 16A is a diagram showing a state where the pop-out preventing part is attached to the container main body;

FIG. 16B is a diagram showing the state where the pop-out preventing part is attached to the container main body; and

FIG. 16C is a diagram showing the state where the pop-out preventing part is attached to the container main body.

### DESCRIPTION OF THE EMBODIMENTS

### First Embodiment

Hereinafter, a first embodiment of the present disclosure will be described with reference to the drawings.

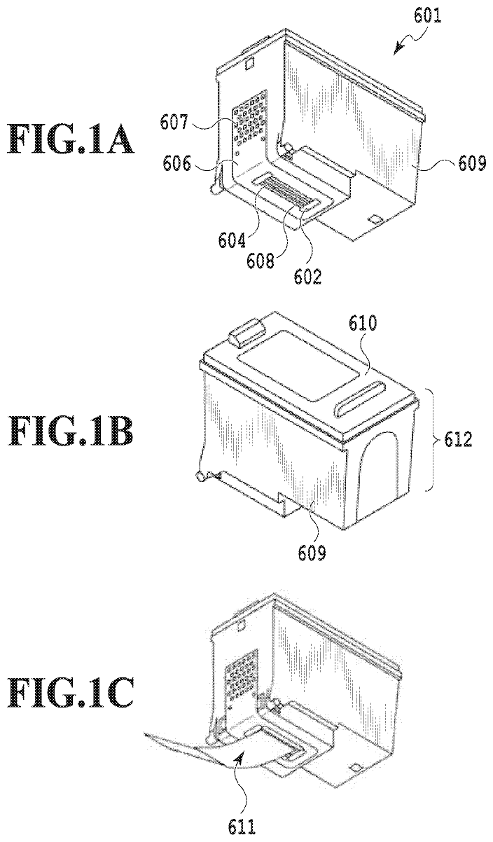

FIG. 1A and FIG. 1B are diagrams showing a liquid ejection head 601 to which the present embodiment can be applied, and FIG. 1C is a diagram showing the liquid ejection head 601 to which a protection tape 611 is attached. In the liquid ejection head 601, a chip-shaped head chip 608 and a case 609 forming an ink tank 612, which is a liquid containing tank, are integrally formed. The head chip 608 includes: a substrate in which heaters for generating thermal energy to be used for ejecting an ink are formed; and a nozzle plate in which ejection ports and the like corresponding to the heaters are formed. To the head chip 608, electric signals are transmitted from a main body of a liquid ejection apparatus via an electric wiring tape 606 and external signal input terminals 607.

The head chip 608 is electrically connected to the electric wiring tape 606 via electric connection portions, and the electric connection portions are covered with sealants 602. The ink tank 612 contains an ink absorber in a space formed by the case 609 and a lid 610. On the head chip 608 side inside the case 609, an ink supply passage (not shown) configured to supply the ink to the head chip 608 is provided. In addition, in an end portion of the ink supply passage, a filter (not shown) is provided. In this way, the ink inside the ink tank 612 is communicated to the head chip 608 via the filter, so that the entering of foreign matters into the ink flow passage and ejection ports inside the head chip 608 is suppressed.

In addition, in the liquid ejection head 601, a protection tape 611 is attached in such a manner as to cover the head chip 608 as protection for the head chip 608. On the head chip 608 side of the protection tape 611, there is an adhesive layer to cover the entire surface of the ejection ports 604.

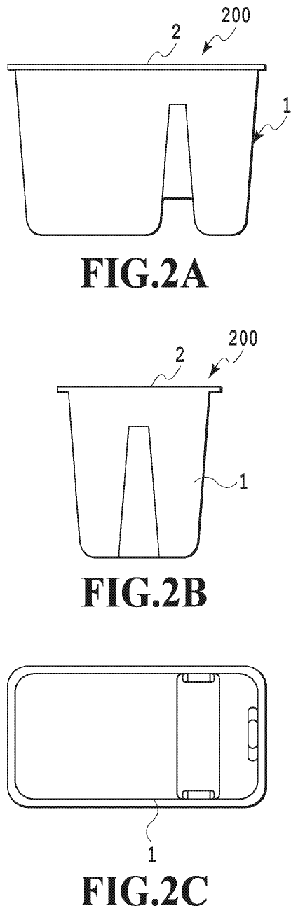

FIG. 2A to FIG. 2C are diagrams showing a housing container 200 configured to house the liquid ejection head 601. FIG. 2A shows a side view, FIG. 2B shows a front view, and FIG. 2C shows a top view. Note that in FIG. 2C, a film sheet 2 is omitted. The housing container 200 includes a container main body 1 and the film sheet 2. The liquid ejection head 601 at the time of new purchase is housed in the container main body 1, and an upper surface of the container main body 1 is covered with the film sheet 2. To mount the liquid ejection head 601 in the liquid ejection apparatus, the user peels off the film sheet 2 to open the upper surface of the container main body 1, and takes out the liquid ejection head 601 from the container main body 1. The film sheet 2 thus peeled off is not supposed to be attached to and seal the upper surface of the container main body 1 again.

After taking out the liquid ejection head 601 from the container main body 1, the user peels off the protection tape 611 which protects the head chip 608 of the liquid ejection head 601 thus taken out, and sets the liquid ejection head 601 in the liquid ejection apparatus, so that the liquid ejection apparatus can eject the ink.

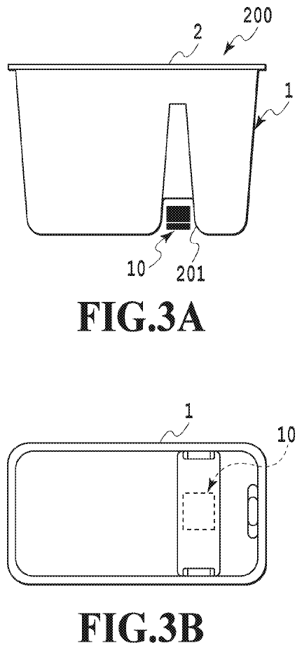

FIG. 3A and FIG. 3B are diagrams showing the housing container 200 in which a pop-out preventing part 10 is stored. FIG. 3A shows a side view, and FIG. 3B shows a top view. Note that in FIG. 3B, the film sheet 2 is omitted. The pop-out preventing part 10 is attached to a bottom recessed portion 201 of the container main body 1. A method for fixing the pop-out preventing part 10 to the bottom recessed portion 201 is supposed to be a method using an adhesive, a method for clamping and fixing the pop-out preventing part 10 to the container main body 1, or the like, but is not limited to this, and the pop-out preventing part 10 may be fixed by any desired method.

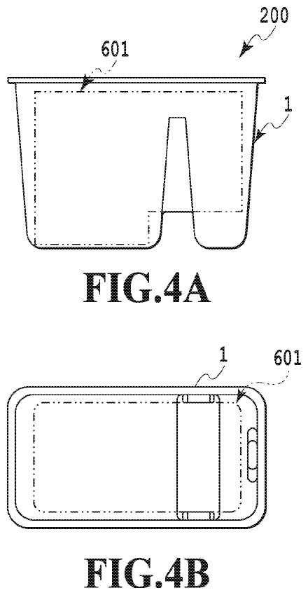

FIG. 4A and FIG. 4B are diagrams showing the container main body 1 in which a used liquid ejection head 601 is housed. FIG. 4A shows a side view, and FIG. 4B shows a top view. In the case where the ink in the liquid ejection head 601 is running short, and the liquid ejection head 601 needs to be replaced, the used liquid ejection head 601 is taken out from the liquid ejection apparatus, and is housed in the container main body 1 as shown in FIG. 4A and FIG. 4B. By setting a new liquid ejection head 601 in the liquid ejection apparatus, the liquid ejection apparatus can be used again.

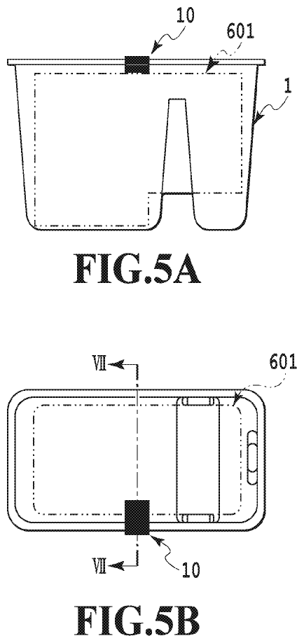

FIG. 5A and FIG. 5B are diagrams showing the container main body 1 which is a package in which the liquid ejection head 601 is stored, where the pop-out preventing part 10 is attached to an edge portion of the container main body 1. FIG. 5A shows a side view, and FIG. 5B shows a top view. The pop-out preventing part 10 detached from the bottom recessed portion 201 of the container main body 1 is attached to the edge portion of a main body opening portion of the container main body 1 in which the liquid ejection head 601 is housed. In FIG. 5A and FIG. 5B, the pop-out preventing part 10 is attached to the edge portion of a side extending in a longitudinal direction of the liquid ejection head 601 among the four sides included in the container main body 1, but may be attached to an edge portion of a side extending in a short-side direction. The pop-out preventing part 10 attached to the edge portion is attached in such a manner as to cover part of the liquid ejection head 601 housed in the container main body 1. In this way, by attaching the pop-out preventing part 10 to the edge portion of the container main body 1, the popping out of the liquid ejection head 601 from the container main body 1 is restricted. The pop-out preventing part 10 is configured to cover part of the liquid ejection head 601 housed in the container main body 1 no matter where the pop-out preventing part 10 is attached as long as it is an edge portion of the container main body 1. For this reason, the attachment of the pop-out preventing part 10 to an edge portion can mitigate the concern that the liquid ejection head 601 would pop out from the container main body 1.

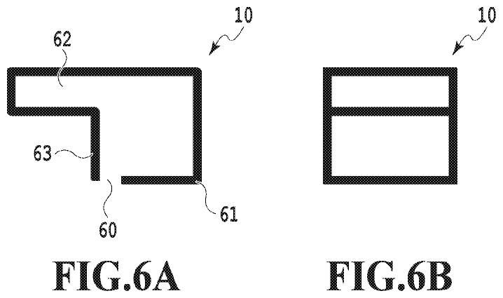

FIG. 6A and FIG. 6B are diagrams showing the pop-out preventing part 10. FIG. 6A shows a side view, and FIG. 6B shows a front view. This pop-out preventing part 10 is formed of a spring plate, and the spring plate is molded from a resin member. Note that the spring plate is not limited to a resin member, and only has to be a spring plate which is formed of a plate having elasticity and does not damage the liquid ejection head 601 even if the liquid ejection head 601 comes in contact with the spring plate. The thickness of the spring plate is desirably 0.5 mm or more and 1.0 mm or less. The pop-out preventing part 10 includes an opening portion 60, a covering portion 61, an edge holding portion 62, and a pressing portion 63, and can be attached to the container main body 1 by fitting the edge portion of the container main body 1 into the opening portion 60. Once the pop-out preventing part 10 is attached to the container main body 1, the pressing portion 63 presses the side surface of the container main body 1, and the covering portion 61 covers part of the main body opening portion of the container main body 1. The covering portion 61 covering part of the main body opening portion of the container main body 1 covers part of the liquid ejection head 601, thereby restricting the popping out of the liquid ejection head 601 from the container main body 1. The edge holding portion 62 will be described later.

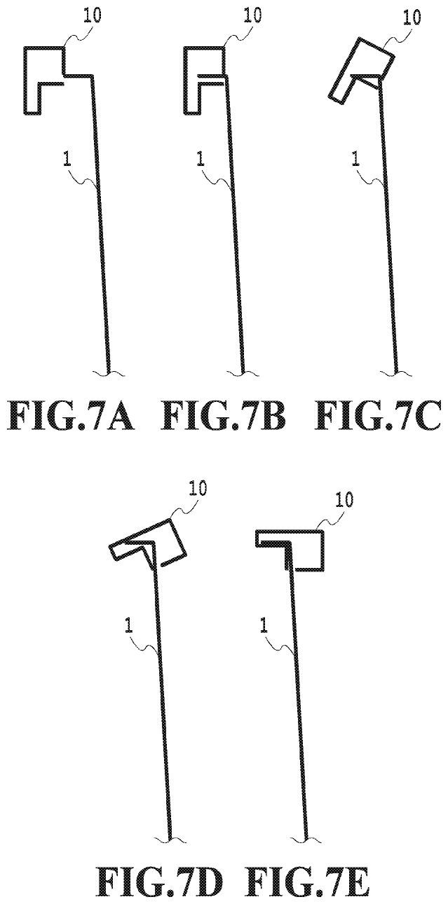

FIG. 7A to FIG. 7E are diagrams showing a procedure for attaching the pop-out preventing part 10 to the edge portion of the container main body 1 in sequence, and are diagrams showing part of a cross-section taken along VII-VII in FIG. 5B. The edge portion of the container main body 1 is, as shown, such that an end portion of the edge portion is bent at an angle close to a substantially right angle. A bent front end of the edge portion is inserted from the opening portion 60 of the pop-out preventing part 10 (see FIG. 7A and FIG. 7B), and then the pop-out preventing part 10 is turned as shown in FIG. 7C and FIG. 7D, so that the pop-out preventing part 10 is bent. Further turning the pop-out preventing part 10 removes the bending of the pop-out preventing part 10, and the pop-out preventing part 10 is brought into a state where the bent front end of the edge portion is inserted and fitted in the edge holding portion 62 (see FIG. 7E). In this way, the pop-out preventing part 10 is attached to the container main body 1 by holding the bent front end of the edge portion in the state where the bent front end is inserted and clamped in the edge holding portion 62 of the pop-out preventing part 10. In this way, the front end of the edge portion is held by the edge holding portion 62, so that the pop-out preventing part 10 is stably attached, and the covering portion 61 can mitigate the concern that the liquid ejection head 601 would pop out from the container main body 1. In addition, by reversing the procedure from FIG. 7A to FIG. 7E, the pop-out preventing part 10 can be detached from the container main body 1.

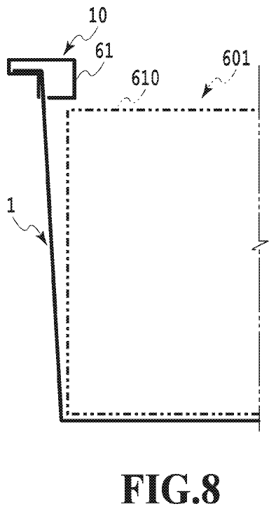

FIG. 8 is a diagram showing the pop-out preventing part 10 attached to the container main body 1 in which the liquid ejection head 601 is housed. As shown in FIG. 8, the covering portion 61 of the pop-out preventing part 10 is configured to cover part of the liquid ejection head 601 housed in the container main body 1. In addition, although the covering portion 61 covers part of the liquid ejection head 601 in a normal orientation as shown in FIG. 8, a clearance is provided between the covering portion 61 and the liquid ejection head 601, so that the covering portion 61 does not come into contact with the liquid ejection head 601. Note that it is desirable that in the state where the pop-out preventing part 10 is housed in the container main body 1, the bottom surface of the covering portion 61 of the pop-out preventing part 10 be close to the lid 610 of the liquid ejection head 601.

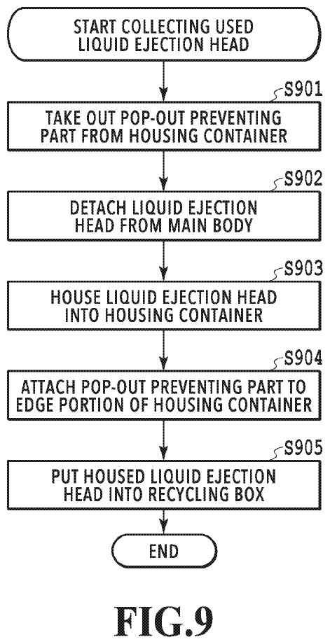

FIG. 9 is a flowchart showing steps of collecting the liquid ejection head 601. Hereinafter, the step of collecting the liquid ejection head 601 will be described by using the flowchart of FIG. 9. The steps of collecting the liquid ejection head 601 is performed by the user at a time point at which the use of the liquid ejection head 601 has ended. Note that the mark “S” in the description of each processing means a step in the flowchart.

Once the steps of collecting the liquid ejection head 601 are started, in S901, the user detaches, from the container main body 1, the pop-out preventing part 10 attached to the bottom recessed portion 201 of the container main body 1. Thereafter, in S902, the user detaches the liquid ejection head 601 from the liquid ejection apparatus. In S903, the user houses, into the container main body 1, the liquid ejection head 601 detached from the liquid ejection apparatus. Then, in S904, the user attaches, to an edge portion of the container main body 1, the pop-out preventing part 10 detached from the container main body 1. In S905, the user puts, into a recycling box, the liquid ejection head 601 housed in the container main body 1, and the collecting steps end.

In the present embodiment, the thickness of the plate forming the pop-out preventing part 10 is set to 0.5 mm or more and 1.0 mm or less. Since the thickness of the edge portion of the container main body 1 is 1.0 mm, the portion for holding the edge portion in the edge holding portion 62 needs to have a width of 1.5 mm for fixing the pop-out preventing part 10. If the thickness of the plate forming the pop-out preventing part 10 is too large, there is a possibility that the edge holding portion 62 cannot have a width of 1.5 mm, and also there are adverse effects such as that flexibility at the time of turning cannot be ensured. In addition, it becomes easy to reuse, at low costs, the material of the pop-out preventing part 10 by using a PCR (Post-Consumer Recycled) material, which is a recycled plastic recycled by using, as raw materials, plastics used and discarded by consumers.

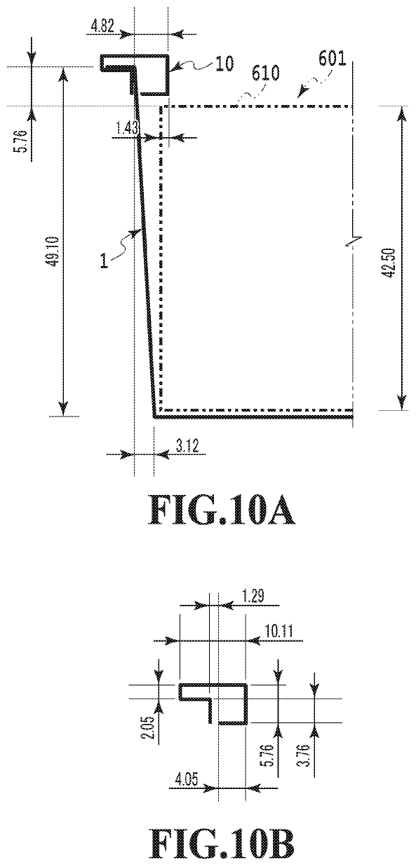

FIG. 10A and FIG. 10B are diagrams showing a dimensional relation between the liquid ejection head 601 and the container main body 1. In an orientation in which the main body opening portion intersects the vertical direction at a right angle, in the state where the pop-out preventing part 10 is housed in the container main body 1, a bottom surface of the covering portion 61 of the pop-out preventing part 10 is extremely close to an upper surface of the lid 610 of the liquid ejection head 601. In the present embodiment, the distance between the bottom surface of the covering portion 61 and the upper surface of the lid 610 is set to 0.84 mm. In addition, it is desirable that the portion, which covers the lid 610 of the liquid ejection head 601, of the covering portion 61 be as wide as possible. In the present embodiment, the portion, which covers the lid 610, of the covering portion 61 is set to 1.43 mm.

With these conditions, the height dimension of the pop-out preventing part 10 is set to a dimension within a distance from an upper end surface of the edge portion of the container main body 1 to an upper end surface of the lid 610 of the liquid ejection head 601. In addition, by setting the inner side of the edge holding portion 62 of the pop-out preventing part 10 to 1.5 mm to intentionally ensure a gap, a shape into which the edge portion can be easily inserted and thus easily fixed is obtained. Moreover, by ensuring about 1.5 mm for the portion, which covers the lid 610 of the liquid ejection head 601, of the covering portion 61, the liquid ejection head 601 is not easily discharged from the container main body 1. Note that the covering portion of the covering portion 61 only has to cover by 1.0 mm or more. In this way, the popping out of the liquid ejection head 601 from the container main body 1 can be suppressed, and the damaging of the head chip 608 can be suppressed.

Note that in the present embodiment, an example in which one pop-out preventing part 10 is attached to the edge portion has been described. However, the configuration is not limited to this. A plurality of pop-out preventing parts 10 may be attached, and the pop-out preventing part 10 only has to be attached to at least one of the four sides.

In this way, the package includes: a container main body capable of housing a liquid ejection head inserted from a main body opening portion having an edge portion; and a fixation member having an edge holding portion configured to clamp and hold the edge portion, and a covering portion configured to restrict popping out of the liquid ejection head from the main body opening portion. This makes it possible to provide a technology for suppressing a decrease in the reuse rate of a liquid ejection head.

### Second Embodiment

Hereinafter, a second embodiment of the present disclosure will be described with reference to the drawings. Note that the basic configurations of the present embodiment are the same as those of the first embodiment, and characteristic configurations will be described below.

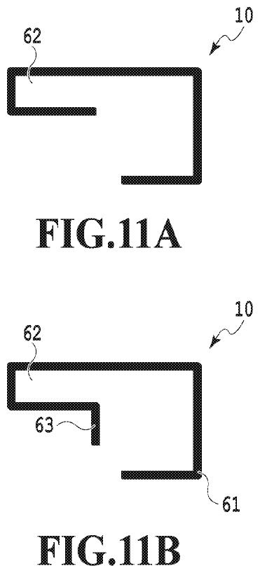

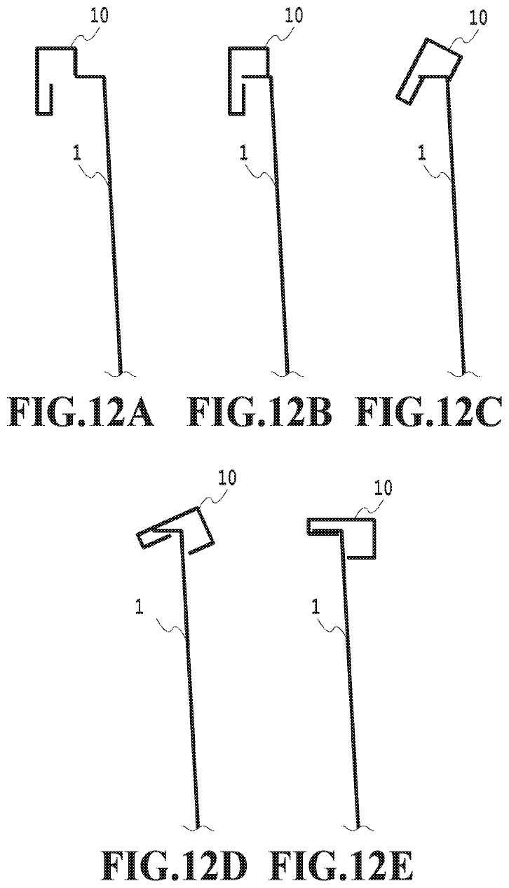

FIG. 11A and FIG. 11B are diagrams showing pop-out preventing parts 10 in the present embodiment. FIG. 12A to FIG. 12E are diagrams showing a procedure for attaching the pop-out preventing part 10 to an edge portion of the container main body 1 in sequence. In the present embodiment, as shown in FIG. 11A, the pop-out preventing part 10 does not have the pressing portion 63 configured to come into contact with an outer contact surface of the container main body 1 in a fixed state as compared with the pop-out preventing part 10 of the first embodiment. In addition, as shown in FIG. 11B, the pressing portion 63 configured to come into contact with the outer contact surface of the container main body 1 in the fixed state is shorter than that of the pop-out preventing part 10 of the first embodiment. Specifically, the pressing portion 63 extends to any position between the edge holding portion 62 and the position of the bottom surface of the covering portion 61.

As in the present embodiment, by eliminating or shortening the pressing portion 63, the holding power of the pop-out preventing part 10 in an outer rotational direction to the container main body 1 becomes weak in the fixed state to the container main body 1. Since the holding power in the outer rotational direction is weak, it becomes possible to easily rotate the pop-out preventing part 10 in the outer rotational direction of the container main body 1 in the case of taking out the used liquid ejection head 601 from the container main body 1. For this reason, in the case of taking out the liquid ejection head 601, the liquid ejection head 601 can be easily taken out from the container main body 1.

Note that as long as a force in the rotational direction is not intentionally applied to the pop-out preventing part 10, since the edge holding portion 62 is holding the edge portion of the container main body 1, the pop-out preventing part 10 does not come off due to vibrations during transportation, or the like.

In this way, with the configuration in which the pressing portion 63 of the pop-out preventing part 10 is eliminated or shortened as well, the effect of the present disclosure can be obtained.

### Third Embodiment

Hereinafter, a third embodiment of the present disclosure will be described with reference to the drawings. Note that the basic configurations of the present embodiment are the same as those of the first embodiment, and characteristic configurations will be described below.

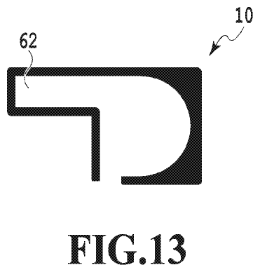

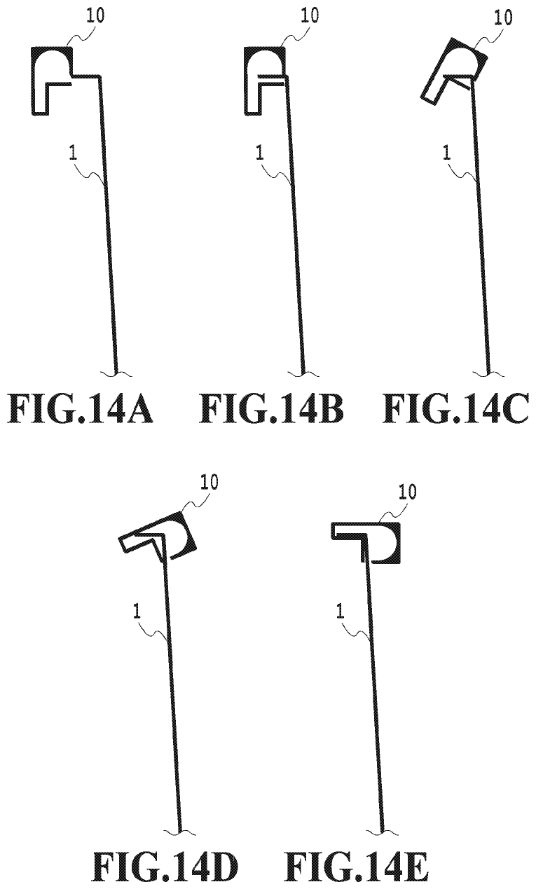

FIG. 13 is a diagram showing a pop-out preventing part 10 in the present embodiment. FIG. 14A to FIG. 14E are diagrams showing a procedure for attaching the pop-out preventing part 10 to an edge portion of the container main body 1 in sequence. In the present embodiment, as shown in FIG. 13, the pop-out preventing part 10 has a configuration in which a corner portion of an inner surface of a covering portion 61 is formed into a rounded corner portion to be reinformed. This can increase the strength of the covering portion 61 in the pop-out preventing part 10, and can mitigate the concern that the liquid ejection head 601 would pop out from the container main body 1 with the pop-out preventing part 10 even in the case where there are vibrations of the liquid ejection head 601 during transportation.

In this way, with the configuration in which the corner portion on an inner side of the covering portion 61 of the pop-out preventing part 10 is reinforced as well, the effect of the present disclosure can be obtained.

### Fourth Embodiment

Hereinafter, a fourth embodiment of the present disclosure will be described with reference to the drawings. Note that the basic configurations of the present embodiment are the same as those of the first embodiment, and characteristic configurations will be described below.

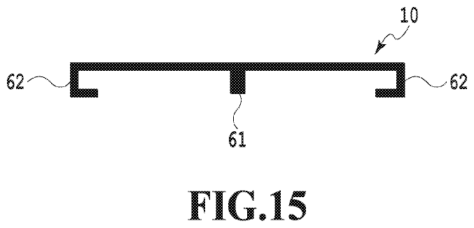

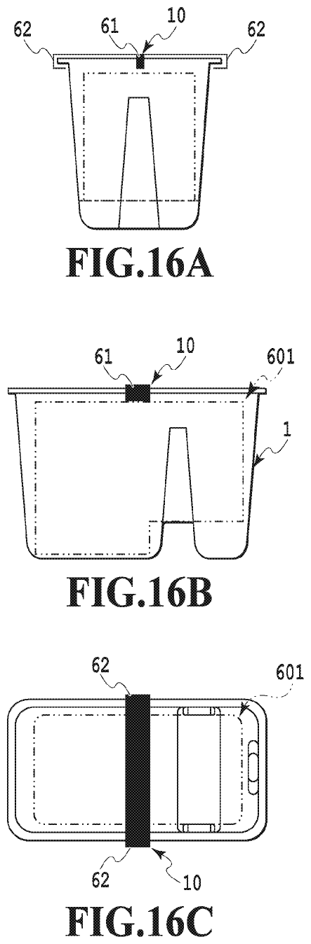

FIG. 15 is a diagram showing a pop-out preventing part 10 in the present embodiment. FIG. 16A to FIG. 16C are diagrams showing a state where the pop-out preventing part 10 is attached to the container main body 1. The pop-out preventing part 10 in the present embodiment is configured to hold two opposite edge portions of the container main body 1 in a state where the two opposite edge portions are inserted and clamped in edge holding portions 62. Thus, the pop-out preventing part 10 in the present embodiment has the configuration in which a fixing strength is increased as compared with the configuration of each above-mentioned embodiment due to the holding at two portions.

The pop-out preventing part 10 has a configuration including the edge holding portions 62 at both ends and being provided with a covering portion 61 at a substantially center. The pop-out preventing part 10 has elasticity, and thus can be warped. In the case of attaching the pop-out preventing part 10 to the edge portions, the pop-out preventing part 10 is first inclined, and one of the edge holding portions 62 is attached to the edge portion. Thereafter, while the pop-out preventing part 10 is bent in such a manner as to be warped, the other edge holding portion 62 is attached to the edge portion. In this way, the pop-out preventing part 10 can be attached to the edge portions. In the case of detaching the pop-out preventing part 10, the pop-out preventing part 10 can be detached from the edge portions by performing the opposite operation to the attaching operation.

As compared with the configuration of the first embodiment, since the liquid ejection head 601 is fixed with the pop-out preventing part 10 using both opposite edge portions of the container main body 1, the pop-out preventing part 10 is excellent in elastic force, and can fix the liquid ejection head 601 by providing the covering portion 61 at the center of the pop-out preventing part 10. In this way, the concern that the pop-out preventing part 10 would come off and the liquid ejection head 601 would pop out from the container main body 1 to outside can be mitigated.

In this way, with the configuration in which the pop-out preventing part 10 includes the edge holding portions 62 at both ends and is provided with the covering portion 61 at a substantially center of the edge holding portions 62 as well, the effect of the present disclosure can be obtained.

The technology described in the present Specification can contribute to the achievement of a sustainable society such as a decarbonized/circular society.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-060685, filed Apr. 1, 2025, which is hereby incorporated by reference herein in its entirety.

What is claimed is:

1. A package configured to house and hold a liquid ejection head, comprising:
a container main body having a main body opening having an edge portion, the container main body being capable of housing the liquid ejection head inserted from the main body opening; and
a fixation member having an edge holding portion configured to clamp and hold the edge portion, and a covering portion configured to restrict popping out of the liquid ejection head from the main body opening.

2. The package according to claim 1, wherein the fixation member is formed of a spring plate, has an opening portion, and is fixed to the container main body by inserting the edge portion from the opening portion.

3. The package according to claim 1, wherein the main body opening has four sides, and the fixation member is attached to at least one of the four sides.

4. The package according to claim 1, wherein the covering portion covers part of the main body opening to restrict the popping out of the liquid ejection head from the main body opening.

5. The package according to claim 1, wherein
in an orientation in which the main body opening intersects a vertical direction at a right angle,
the liquid ejection head housed in the container main body does not come into contact with the fixation member, and
a bottom surface of the covering portion is located at a position higher than an upper surface of the liquid ejection head.

6. The package according to claim 1, wherein the container main body is provided to be capable of housing, in a recessed portion, the fixation member before being fixed.

7. The package according to claim 6, wherein the package is provided to be capable of housing a plurality of the fixation members in the recessed portion.

8. The package according to claim 1, wherein the fixation member includes a pressing portion connected to the edge holding portion and provided with a contact surface configured to come into contact with an outer contact surface of the container main body in a state where the fixation member is fixed to the container main body.

9. The package according to claim 8, wherein the pressing portion extends from the edge holding portion to a position of a bottom surface of the fixation member in an orientation where the fixation member is fixed to the container main body.

10. The package according to claim 8, wherein the pressing portion extends to any position between the edge holding portion and the position of the bottom surface of the fixation member in the orientation where the fixation member is fixed to the container main body.

11. The package according to claim 1, wherein the fixation member does not include a contact surface connected to the edge holding portion and configured to come into contact with an outer contact surface of the container main body in a state where the fixation member is fixed to the container main body.

12. The package according to claim 2, wherein a thickness of the spring plate is 0.5 mm or more and 1.0 mm or less.

13. The package according to claim 2, wherein a corner portion of an inner surface of the covering portion is reinforced with a rounded corner portion.

14. The package according to claim 4, wherein a bottom surface of the covering portion covers an upper surface of the liquid ejection head from an end portion of the liquid ejection head by 1.0 mm or more.

15. The package according to claim 1, wherein the fixation member is formed of a recycled plastic.

16. The package according to claim 1, comprising a plurality of the fixation members.

17. The package according to claim 1, configured to house and hold the liquid ejection head including a liquid containing tank.

18. A method for collecting a liquid ejection head, comprising: transporting the liquid ejection head by using a package in which a fixation member is fixed to a container main body housing the liquid ejection head inserted from a main body opening having an edge portion, the fixation member having an edge holding portion configured to clamp and fix the edge portion, and a covering portion configured to restrict popping out of the liquid ejection head from the main body opening.
